(19) United States
(12) Patent Application Publication
(10) Pub. No.: US 2005/0113122 A1
(43) Pub. Date: May 26, 2005

(54) Push-to-talk indicator for wireless device

(75) Inventor: Jose E. Korneluk, Boynton Beach, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 10/722,284

(22) Filed: Nov. 25, 2003

(51) Int. Cl. H04Q 7/20

(52) U.S. Cl. 455/518; 455/516; 455/566

(57) ABSTRACT

A system, method and computer readable medium for providing a push-to-talk indicator on a wireless device is disclosed. The method on a wireless device includes indicating, via a push-to-talk indicator, that a user of the wireless device may not provide audio for transmission. The method further includes initiating, by the wireless device, a connection setup procedure with a wireless network, and receiving a message from the wireless network indicating establishment of a connection. The method further includes indicating, via the push-to-talk indicator, that the user of the wireless device may provide audio for transmission. The push-talk-talk indicator is a backlit button that emits a green light to indicate an open channel and red light to indicate that the channel is not open.

### FIELD OF THE INVENTION

The present invention generally relates to the field of wireless communications, and more particularly relates to push-to-talk wireless devices.

### BACKGROUND OF THE INVENTION

With the advent of pagers and mobile phones the wireless service industry has grown into a multi-billion dollar industry. Recently, push-to-talk wireless devices have grown in popularity. Push-to-talk wireless devices allow two-way analog radio-like communication in which only one user can speak at once and a user pushes a button to commence speaking. Unlike conventional two-way analog radios, however, network push-to-talk wireless devices require a private call setup and a talk ready tone. That is, when a user pushes a push-to-talk button, the wireless network proceeds to initiate a private call setup and subsequently, upon the successful completion of the setup, the wireless device issues a talk ready tone to indicate to the user that he may begin speaking.

Additionally, push-to-talk communications do not allow more than one party to speak at once. As soon as a first party presses the push-to-talk button, the first party controls the call and his voice is transmitted until he releases the push-to-talk button. When the first party has released the button, he no longer controls the call and control goes to the next party that pushes the push-to-talk button. Thus, when one or more parties are talking on a private or group call, only one party can have the push-to-talk button pressed. If a first party attempts to push the push-to-talk button when another party has control of the call, the wireless device of the first party responds with an undesirable “bonk,” talk prohibit tone, or other audio signal indicating that the first party cannot transmit audio at the given moment.

This undesirable audio signal can be annoying and disconcerting to the user. In addition, the undesirable audio signal can be annoying to bystanders or other situated near the user of the wireless device. Further, the restriction on transmitting audio is a departure from the well known conventional (i.e. non-networked) two-way analog radio communication protocol in which a user simply pushes the push-to-talk button and can immediately being speaking, regardless of whether another party is also speaking at the moment.

Therefore a need exists to overcome the problems with the prior art as discussed above.

### SUMMARY OF THE INVENTION

Briefly, in accordance with the present invention, disclosed is a system, method and computer readable medium for providing a push-to-talk indicator on a wireless device. In an embodiment of the present invention, the method on a wireless device includes indicating, via a push-to-talk indicator, that a user of the wireless device may not provide audio for transmission. The method further includes initiating, by the wireless device, a connection setup procedure with a wireless network, and receiving a message from the wireless network-indicating establishment of a connection. The method further includes indicating, via the push-to-talk indicator, that the user of the wireless device may provide audio for transmission. In one embodiment of the present invention, the push-talk-talk indicator is a backlit button that emits a green light to indicate an open channel and red light to indicate that the channel is not open.

In another embodiment of the present invention, the method on a wireless device includes indicating, via a push-to-talk indicator, that a user of the wireless device may not provide audio for transmission. The method further includes receiving a request to join a connection setup procedure with a wireless network, and receiving a message from the wireless network-indicating establishment of a connection. The method further includes receiving audio from the wireless network originating from another user on another wireless device and detecting the passage of a predefined period of time. The method further includes indicating, via the push-to-talk indicator, that the user of the wireless device may provide audio for transmission. In one embodiment of the present invention, the push-talk-talk indicator is a backlit button that emits a green light to indicate an open channel and red light to indicate that the channel is not open.

In another embodiment of the present invention, a push-to-talk wireless device including a push-to-talk indicator includes a processor for initiating a connection setup procedure with a wireless network. The push-to-talk wireless device further includes a receiver for receiving a message from the wireless network-indicating establishment of a connection and a push-to-talk button for pushing when the user desires to provide audio for transmission. The push-to-talk wireless device further includes a push-to-talk indicator for indicating that the user of the wireless device may provide audio for transmission after the connection has been established and the message is received from the wireless network, otherwise for indicating that the user of the wireless device may not provide audio for transmission. In another embodiment of the present invention, the push-to-talk wireless device further includes a transmitter for sending a call request to the wireless network when initiating a connection setup procedure with the wireless network.

The preferred embodiments of the present invention are advantageous because they provide an alternative to an undesirable audio signal indicating a busy channel. The present invention allows a user to simply look at the push-to-talk indicator before pushing it to determine whether the channel is free for talking. This allows for a smoother and more natural communication experience for the user of the wireless device. In addition, this paradigm eliminates the requirement of an undesirable audio signal indicating a busy channel, which can be annoying to the user and to others who are near the user.

In another embodiment of the present invention, the push-to-talk indicator comprises a light, button or other mechanical element that is located on wireless device or a graphical indicator, such as an icon, a text message, which is displayed on external display of the wireless device.

### BRIEF DESCRIPTION OF THE DRAWINGS

FIG. 1 is a block diagram illustrating a wireless communication system according to a preferred embodiment of the present invention.

FIG. 2 is a more detailed block diagram of the wireless communication system of FIG. 1.

FIG. 3 is a block diagram illustrating a wireless device according to a preferred embodiment of the present invention.

FIG. 4 is an operational flow diagram for a call setup process of a push-to-talk wireless device on a wireless network according to a preferred embodiment of the present invention.

FIG. 5 is a chronological diagram for a call setup process of a push-to-talk wireless device on a wireless network according to a preferred embodiment of the present invention.

FIG. 6 is timing diagram for a call process of a push-to-talk wireless device on a wireless network according to a preferred embodiment of the present invention.

### DETAILED DESCRIPTION

The present invention, according to a preferred embodiment, overcomes problems with the prior art by providing a method for users of a push-to-talk wireless device to determine whether a channel is free for transmission.

FIG. 1 is a block diagram illustrating a wireless communication system according to a preferred embodiment of the present invention. The exemplary wireless communication system of FIG. 1 includes a wireless service provider 102, a wireless network 104 and wireless devices 106 through 108. The wireless service provider 102 is a first-generation analog mobile phone service, a second-generation digital mobile phone service or a third-generation Internet-capable mobile phone service. The exemplary wireless network 104 is a mobile phone network, a mobile text messaging device network, a pager network, or the like. Further, the communications standard of the wireless network 104 of FIG. 1 is Code Division Multiple Access (CDMA), Time Division Multiple Access (TDMA), Global System for Mobile Communications (GSM), General Packet Radio Service (GPRS), Frequency Division Multiple Access (FDMA) or the like. The wireless network 104 supports any number of wireless devices 106 through 108, which are mobile phones, push-to-talk mobile radios, text messaging devices, handheld computers, pagers, beepers, or the like.

In an embodiment of the present invention, the wireless network 104 is the Motorola Integrated Digital Enhanced Network (iDEN™), which is a wireless solution designed for a variety of mobile business applications. iDEN wireless devices can be utilized in a variety of work environments ranging from manufacturing floors to executive conference rooms as well as mobile sales forces. iDEN wireless devices provide a variety of functions including two-way digital radio; digital wireless phone; alphanumeric messaging; and data/fax capabilities leveraging Internet access technology. iDEN wireless devices further include a variety of features, including speakerphone, voice command, phone book, voice mail, digital two-way radio, mobile Internet and e-mail, wireless modems, voice activation, and voice recordings. The Motorola iDEN network is described more fully in co-owned U.S. Pat. No. 5,548,631, entitled “Method and Apparatus for Supporting at Least Two Communications Services in a Communication System.” U.S. Pat. No. 5,548,631 is incorporated by reference in its entirety.

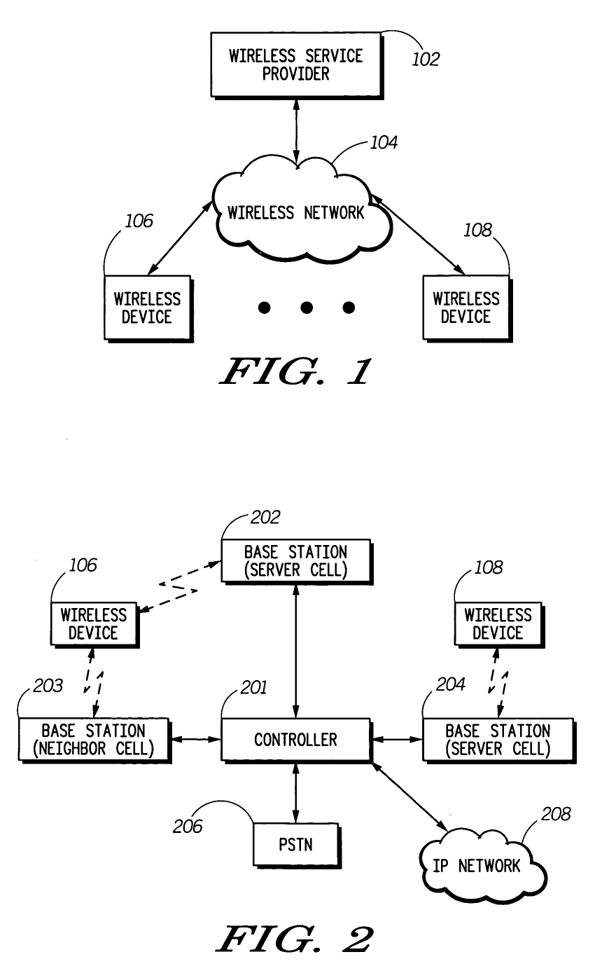

FIG. 2 is a more detailed block diagram of the wireless communication system of FIG. 1. The wireless communication system of FIG. 2 includes a controller 201 coupled to base stations 202, 203, 204, which support any of the communication standards cited above. In addition, the wireless communication system of FIG. 2 is interfaced to the Public Switched Telephone Network (PSTN) 206 and an Internet Protocol (IP) network 208. The base stations 202, 203, 204 individually support portions of a geographic coverage area containing subscriber units or transceivers (i.e., mobile devices) 106 and 108 (see FIG. 1). The mobile devices 106 and 108 interface with the base stations 202, 203, 204 using a communication protocol, such as CDMA, FDMA, CDMA, GPRS or GSM.

The geographic coverage area of the wireless communication system of FIG. 2 is divided into regions or cells, which are individually serviced by the base stations 202, 203, 204 (also referred to herein as cell servers). A mobile device operating within the wireless communication system selects a particular cell server as its primary interface for receive and transmit operations within the system. For example, mobile device 106 has cell server 202 as its primary cell server, and mobile device 108 has cell server 204 as its primary cell server. Preferably, a mobile device selects a cell server that provides the best communication interface into the wireless communication system. Ordinarily, this will depend on the signal quality of communication signals between a mobile device and a particular cell server.

As a mobile device moves between various geographic locations in the coverage area, a hand-off or hand-over may be necessary to another cell server, which will then function as the primary cell server. A mobile device monitors communication signals from base stations servicing neighboring cells to determine the most appropriate new server for hand-off purposes. Besides monitoring the quality of a transmitted signal from a neighboring cell server, the mobile device also monitors the transmitted color code information associated with the transmitted signal to quickly identify which neighbor cell server is the source of the transmitted signal.

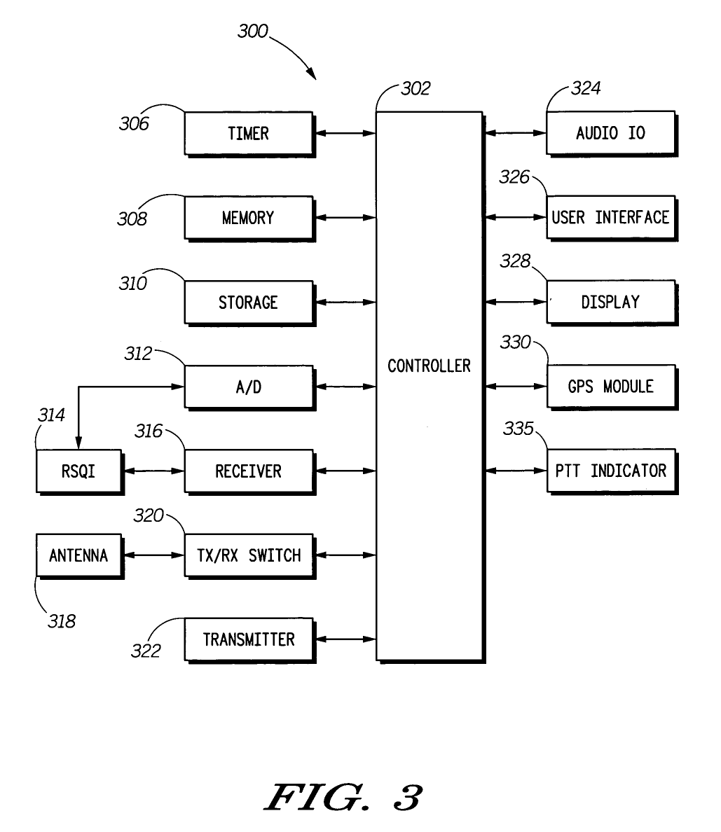

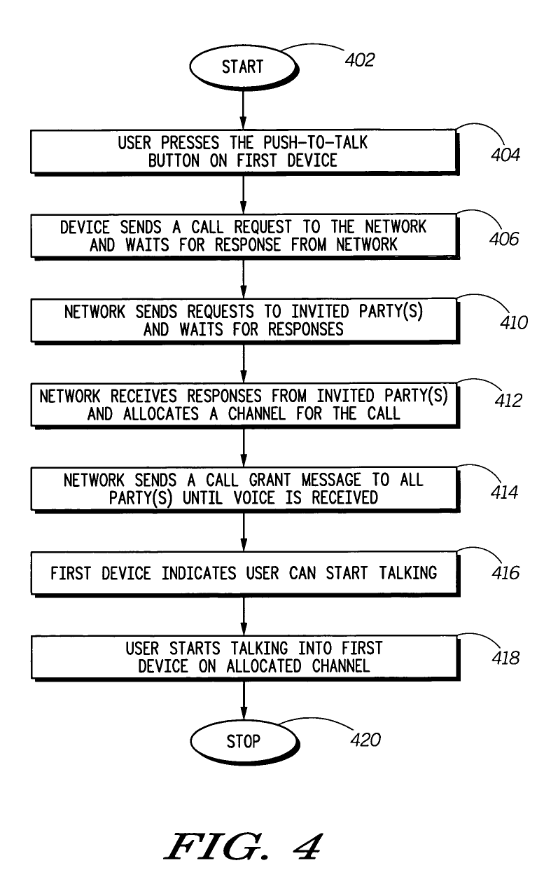

FIG. 3 is a block diagram illustrating a wireless device 300 according to a preferred embodiment of the present invention. FIG. 3 shows a mobile telephone wireless device 300. In one embodiment of the present invention, the wireless device 300 is a two-way radio capable of receiving and transmitting radio frequency signals over a communication channel under a communications protocol such as Code Division Multiple Access (CDMA), Time Division Multiple Access (TDMA), Global System for Mobile Communications (GSM), General Packet Radio Service (GPRS), Frequency Division Multiple Access (FDMA) or the like.

Controller 302 in FIG. 3 performs various functions such as the functions attributed to the push-to-talk indicator, as described below. In various embodiments of the present invention, the controller 302 in FIG. 3 comprises a single processor or more than one processor for performing the tasks described below. The wireless device 300 operates under the control of the controller 302, which switches the wireless device 300 between receive and transmit modes. In receive mode, the controller 302 couples an antenna 318 through a transmit/receive switch 320 to a receiver 316. The receiver 316 decodes the received signals and provides those decoded signals to the controller 302. In transmit mode, the controller 302 couples the antenna 318, through the switch 320, to a transmitter 322. FIG. 3 also includes a storage module 310 for storing information that may be used during the overall processes of the present invention.

The controller 302 operates the transmitter 322 and receiver 316 according to instructions stored in memory 308. These instructions include a neighbor cell measurement-scheduling algorithm. In preferred embodiments of the present invention, memory 308 comprises any one or any combination of non-volatile memory, Flash memory or Random Access Memory. A timer module 306 provides timing information to the controller 302 to keep track of timed events. Further, the controller 302 utilizes the time information from the timer module 306 to keep track of scheduling for neighbor cell server transmissions and transmitted color code information.

When a neighbor cell measurement is scheduled, the receiver 316, under the control of the controller 302, monitors neighbor cell servers and receives a “received signal quality indicator” (RSQI). An RSQI circuit 314 generates RSQI signals representing the signal quality of the signals transmitted by each monitored cell server. Each RSQI signal is converted to digital information by an analog-to-digital converter 312 and provided as input to the controller 302. Using the color code information and the associated received signal quality indicator, the wireless device 300 determines the most appropriate neighbor cell server to use as a primary cell server when hand-off is necessary.

In one embodiment, the wireless device 300 is a wireless telephone. For this embodiment, the wireless device 300 of FIG. 3 further includes an audio input/output module 324 for allowing the input of audio into the wireless device 300 and the output of audio for listening by a user. Also included is a user interface 326 for allowing the user to interact with the wireless device 300, such as modifying address book information, interacting with call data information and making/answering calls. Wireless device 300 further includes a display 328 for displaying information to the user of the mobile telephone.

FIG. 3 further shows a push-to-talk indicator 335 for indicating to a user whether a channel is open. As explained above, push-to-talk communications do not allow more than one party to speak at once. As soon as a first party presses the push-to-talk button, the first party controls the call and his voice is transmitted until he releases the push-to-talk button. When the first party has released the button, he no longer controls the call and control goes to the next party that pushes the push-to-talk button. Thus, when one or more parties are talking on a private or group call, only one party can have the push-to-talk button pressed. If a first party attempts to push the push-to-talk button when another party has control of the call, the wireless device of the first party responds with an undesirable “bonk” or other audio signal indicating that the first party cannot transmit audio at the given moment. This undesirable audio signal can be annoying and disconcerting to the user. In addition, the undesirable audio signal can be annoying to bystanders or other situated near the user of the wireless device.

In an embodiment of the present invention, the push-to-talk indicator 335 comprises a push-to-talk backlit button. When the channel of the current private or group call is open for audio by a user of the wireless device 300, i.e., when no other party controls the call, the push-to-talk indicator 335 is backlit by a green color. This indicates to the user of the wireless device 302 that he may provide audio for transmission. When the channel of the current private or group call is not open for audio by the user of the wireless device 300, i.e., when another party controls the call, the push-to-talk indicator 335 is backlit by a red color. This indicates to the user of the wireless device 302 that he may not provide audio for transmission. Alternatively, the push-to-talk indicator 335 comprises a light, button or other mechanical element that is located on the interface 326 of the wireless device 302.

In this embodiment, the push-to-talk indicator 335 is integrated with a push-to-talk button that is backlit. Therefore, the push-to-talk indicator 335 includes the functionality of a push-to-talk indicator 335 that indicates the push-to-talk status of the wireless device 300 and a push-to-talk button that is used to affect the push-to-talk status of the wireless device 300.

In another embodiment of the present invention, the push-to-talk indicator 335 comprises a graphical indicator, such as an icon, a text message, or a combination of the two, which is displayed on external display 328 of the wireless device 302. In this embodiment, the push-to-talk indicator 335 is separate from a push-to-talk button. Therefore, the push-to-talk indicator 335 including the functionality of a push-to-talk indicator 335 that indicates the push-to-talk status of the wireless device 300 is realized in an item that is separate from a push-to-talk button that is used to affect the push-to-talk status of the wireless device 300.

FIG. 3 also shows an optional Global Positioning System (GPS) module 330 for determining location and/or velocity information of the wireless device 300. This module 330 uses the GPS satellite system to determine the location and/or velocity of the wireless device 300. Alternative to the GPS module 330, the wireless device 300 may include alternative modules for determining the location and/or velocity of wireless device 300, such as using cell tower triangulation and assisted GPS.

FIG. 4 is an operational flow diagram for a call setup process of a push-to-talk wireless device on a wireless network according to a preferred embodiment of the present invention. The operational flow diagram of FIG. 4 depicts the process of setting up a call (i.e., call setup) for a push-to-talk wireless device 300 on a wireless network 104. The operational flow diagram of FIG. 4 begins with step 402 and flows directly to step 404.

Prior to step 404, there is no connection established between wireless devices and therefore there is no other party controlling the call. Therefore, push-to-talk indicator 335 indicates to the user of the wireless device 300 that he may provide audio for transmission. In one embodiment, the push-to-talk indicator 335 is backlit by a green color.

In step 404, the user of the wireless device 300 presses the push-to-talk button. This indicates to the wireless device 300 that the user is ready to being transmitting audio. Then, the wireless device 300, in step 406, sends a private or group call request to the wireless network 104 and waits for a response. In an embodiment of the present invention, the wireless device 300, in step 406, sends a Layer Three signaling message, known to those of ordinary skill in the art. The message can be a “PC_REQUEST” message for a private call request (i.e., a call including only two parties) or a “GC_REQUEST” message for a group call request (i.e., a call including more than two parties).

In step 410, the wireless network 104 proceeds to attempt to set up a call between the wireless device 300 and the intended recipient(s) of the call. The wireless network 104 sends call requests to the intended recipient(s) of the call and waits for responses from the recipients. In an embodiment of the present invention, the wireless network 104, in step 410, sends a Layer Three “GC_PAGE_REQUEST” message for a private call or a “GC_PAGE_REQUEST” message for a group call. In a further embodiment, while the network 104 waits for the responses from the recipients, the wireless network 104 sends a “call proceeding” message to all parties. In this embodiment, “call proceeding” message is a Layer Three “GC_PROCEEDING” message for a private call or a “GC_PROCEEDING” message for a group call.

The wireless network 104 proceeds to complete a connection with the intended recipient(s) of the call and subsequently allocates a channel for communication for the wireless device 300.

Next, the wireless network 104, in step 414, sends a call grant message to the wireless device 300 and the intended recipient(s) of the call. The call grant message is a message indicating to a wireless device that a connection has been made and that a channel for communication has been allocated. In an embodiment of the present invention, the wireless network 104, in step 414, sends a Layer Three “PC_GRANT” message for a private call or a “GC_GRANT” message for a group call.

In response to receiving the call grant message from the wireless network 104, the channel of the current private or group call is not open for audio for any other user than the user of the wireless device 300, i.e., the user of the wireless device 300 controls the call. Therefore, the push-to-talk indicator 335 for all other parties (other than wireless device 300) indicates that he may not provide audio for transmission. In one embodiment, the push-to-talk indicator 335 for all other parties is backlit a red color.

Also in response to receiving the call grant message from the wireless network 104, the wireless device 300, in step 416, indicates to the user that the wireless device 300 is ready to begin receiving audio for transmission. In one embodiment, the wireless device 300 indicates this by generating a beep or other representative tone. Subsequently, the user begins sending audio (by speaking into the wireless device 300, for example) via the wireless device 300, in step 418, over the channel allocated by the wireless network 104. The wireless device 300 transmits audio from the user to the wireless network 104, which in turn transmits the audio to the other party(s) participating in the call. Step 418 signals the start of the communication component of the call. The operational flow diagram of FIG. 4 ceases in step 420.

In the event that the wireless network 104 does not allocate a channel for wireless device 300 because the call setup procedure was not successful (for example, due to the unavailability of RF channels or the unavailability of the receiving wireless device), then in an alternative step, the wireless network 104 notifies the user of the wireless device 300 that the call setup has failed. In another preferred embodiment, voice announcements are provided to the wireless device 300 indicating the status of the call setup procedure.

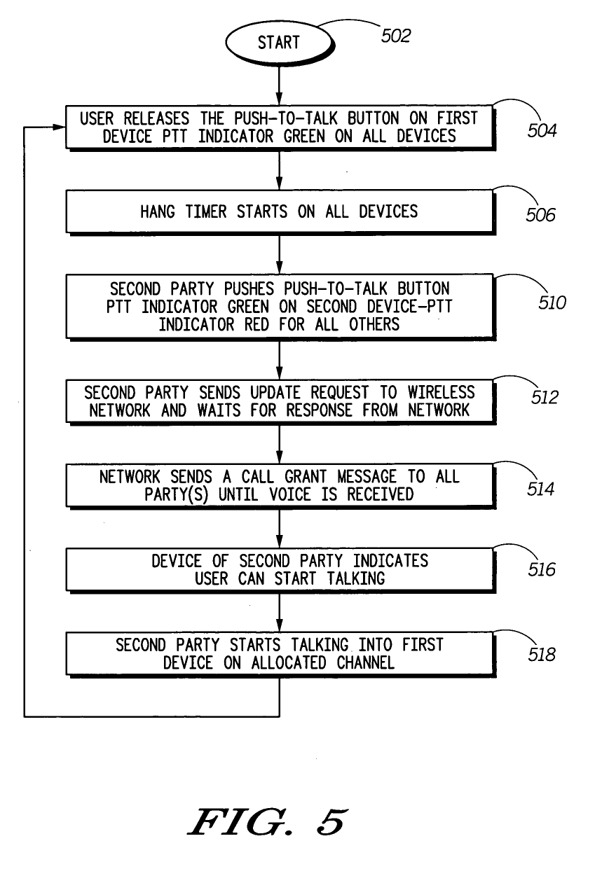

FIG. 5 is an operational flow diagram for a call process of a push-to-talk wireless device on a wireless network according to a preferred embodiment of the present invention. The operational flow diagram of FIG. 5 depicts the communications component of a call for a push-to-talk wireless device 300 on a wireless network 104, transpiring after the call setup process, depicted in greater detail with reference to FIG. 4 above. Thus, the steps described in FIG. 5 occur after the steps described in FIG. 4. above. The operational flow diagram of FIG. 5 begins with step 502 and flows directly to step 504.

The steps of FIG. 4 ended with the user of the wireless device 300 sending audio via the wireless device 300, in step 418, over the channel allocated by the wireless network 104. The wireless device 300 transmits audio from the user to the wireless network 104, which in turn transmits the audio to the other party(s) participating in the call. At the end of FIG. 4, at step 418, the user of the wireless device 300 remains pushing the push-to-talk button (as he is still transmitting audio). At the beginning of FIG. 5, the user of the wireless device 300 has released the push-to-talk button.

In step 504, the user of the wireless device 300 releases the push-to-talk button. Subsequently, an end-of-transmission message is sent to the wireless network 104 from the wireless device 300. In an embodiment of the present invention, the wireless device 300, in step 504, sends a Layer Three “PC_EOT” message for a private call or a “GC_EOT” message for a group call. In step 506, a hang timer, running on each wireless device including wireless device 300, starts detecting the passage of time. At this point, any party can push their respective push-to-talk button. The first party to do this will control the call.

In step 510, a second party pushes his push-to-talk button. In step 512, the wireless device of the second party sends an update request to the wireless network 104. Prior to step 510, there is no connection established between any wireless device and the network. Therefore, the push-to-talk indicator 335 indicates to the user of the wireless device 300 that he may provide audio for transmission. In one embodiment, the push-to-talk indicator 335 is backlit by a green color. Further, the push-to-talk indicator 335 for all other parties indicates to those users that they may provide audio for transmission. In one embodiment, those push-to-talk indicators 335 are backlit by a green color.

In an embodiment of the present invention, the wireless device of the second party, in step 512, sends a Layer Three “GC_UPDATE_REQLEST” message for a private call or a “GC_UPDATE_REQUEST” message for a group call. Consequently, the wireless network 104, in step 514, sends a call grant message to the other party(s) of the call. The call grant message is a message indicating to a wireless device that a connection has been made and that a channel for communication has been allocated.

In response to receiving the call grant message from the wireless network 104, the channel of the current private or group call is not open for audio for any other user than the second party, i.e., the second party controls the call. Therefore, the push-to-talk indicator 335 for all other parties (other than the second party) indicates that he may not provide audio for transmission. In one embodiment, the push-to-talk indicator 335 for all other parties is backlit a red color.

Also in response to receiving the call grant message from the wireless network 104, the wireless device of the second party, in step 516, indicates to the user that his wireless device is ready to begin receiving audio for transmission. Subsequently, the second party begins sending audio, in step 518, over the channel allocated by the wireless network 104. The wireless device of the second party transmits audio to the wireless network 104, which in turn transmits the audio to the other party(s) participating in the call. Step 518 signals the start of another communication component of the call. Step 518 flows to back to step 504, where the second party releases the push-to-talk button. Thus, steps 504-518 are repeated until the private or group call is terminated.

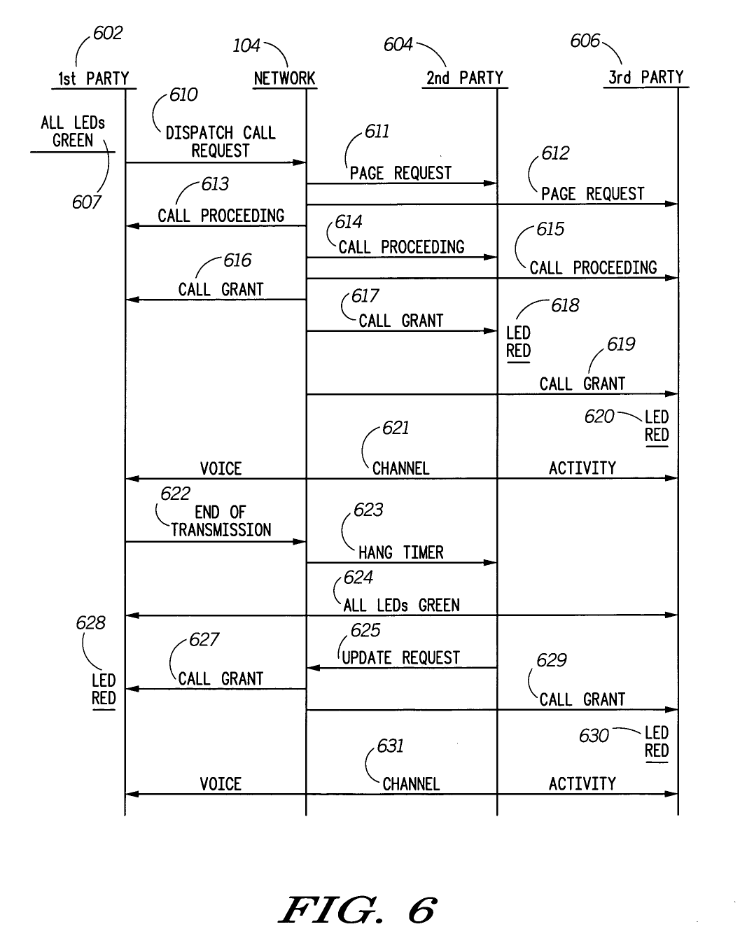

FIG. 6 is timing diagram for a call process of a push-to-talk wireless device on a wireless network according to a preferred embodiment of the present invention. The diagram of FIG. 6 depicts the process of setting up and executing a call for a push-to-talk wireless device on a wireless network 104. The diagram of FIG. 6 shows a group call including a first party 602, a second party 604 and a third party 606.

Prior to the execution of the diagram of FIG. 6, there is no connection established between wireless devices and therefore there is no other party controlling the call. Therefore, push-to-talk indicator 335 indicates to all users that they may provide audio for transmission. Thus, all push-to-talk indicators, or LEDs, are green 607.

The first party 602 presses the push-to-talk button. The wireless device sends a GC_REQUEST 610 to the wireless network 104 and waits for a response. In response the wireless network 104 sends a GC_PAGE_REQUEST 611 and 612 to the intended recipient(s) of the call, second party 604 and third party 606, and waits for responses from the recipients. While the network 104 waits for the responses from the recipients, the wireless network 104 sends a GC_PROCEEDING message 613, 614 and 615 to all parties.

Next, the wireless network 104 sends a GC_GRANT message 616, 617 and 619 to all parties of the call. In response to receiving the call grant message from the wireless network 104, the channel of the current group call is not open for audio for any other user than the first party 602. Therefore, the LED is red 618 for the second party 604 and the LED is red 620 for the third party 606.

Subsequently, the first party begins sending audio (typically voice 621) over the channel allocated by the wireless network 104. The wireless network 104 transmits the audio to the other party(s) participating in the call. Then, the first party 602 releases the push-to-talk button. Subsequently, a GC_EOT message 622 is sent to the wireless network 104 from the first party 602. At this point, all push-to-talk indicators remain as they were. Subsequently a hang timer 623, running on each wireless device, starts detecting the passage of time. When a predefined period of time has been detected by the hang timer, it is determined that no party controls the call. Therefore, all LEDs are green 624.

The, the second party 604 pushes his push-to-talk button. The wireless device of the second party 604 sends a GC_UPDATE_REQUEST 625 to the wireless network 104. Consequently, the wireless network 104, sends a GC_GRANT message 627 and 628 to the first party 602 and third party 606. The call grant message is a message indicating to a wireless device that a connection has been made and that a channel for communication has been allocated. In response to receiving the call grant message from the wireless network 104, the channel of the current private or group call is not open for audio for any other user than the second party, i.e., the second party 604 controls the call. Therefore, the LED is green 626 for the second party 604 while the LED is red 628 for the first party 602 and the LED is red 630 for the third party 606. Subsequently, the second party 604 begins sending audio, typically voice 631, over the channel allocated by the wireless network 104. The wireless network 104 transmits the audio to the other party(s) participating in the call.

The present invention can be realized in hardware, software, or a combination of hardware and software in the wireless device 300. A system according to a preferred embodiment of the present invention can be realized in a centralized fashion in one computer system (of the wireless device 300), or in a distributed fashion where different elements are spread across several interconnected computer systems. Any kind of computer system—or other apparatus adapted for carrying out the methods described herein—is suited. A typical combination of hardware and software could be a general-purpose processor with a computer program that, when being loaded and executed, controls the processor such that it carries out the methods described herein.

The present invention can also be embedded in a computer program product (e.g., in the wireless device 300), which comprises all the features enabling the implementation of the methods described herein, and which—when loaded in a system is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

1. A method on a wireless device for providing a push-to-talk indicator, comprising:
first indicating, via a push-to-talk indicator, that a user of the wireless device may not provide audio for transmission;
initiating, by the wireless device, a connection setup procedure with a wireless network;
receiving a message from the wireless network indicating establishment of a connection; and
second indicating, via the push-to-talk indicator, that the user of the wireless device may provide audio for transmission.

2. The method of claim 1, wherein the first indicating comprises:
indicating, via a push-to-talk backlit button, that a user of the wireless device may not provide audio for transmission.

3. The method of claim 1, wherein the first indicating comprises:
indicating, via a push-to-talk backlit button that is lit in red color, that a user of the wireless device may not provide audio for transmission.

4. The method of claim 3, wherein the second indicating comprises:
indicating, via a push-to-talk backlit button that is lit in green color, that a user of the wireless device may provide audio for transmission.

5. The method of claim 1, wherein the initiating, by the wireless device, a connection setup procedure with a wireless network includes the sub-step of sending a call request to the wireless network.

6. The method of claim 1, further comprising:
detecting the user pushing the push-to-talk button; and
receiving audio from the user for transmission.

7. A method on a wireless device for providing a push-to-talk indicator, comprising:
first indicating, via a push-to-talk indicator, that a user of the wireless device may not provide audio for transmission;
receiving a request to join a connection setup procedure with a wireless network;
receiving a message from the wireless network indicating establishment of a connection;
receiving audio from the wireless network originating from another user on another wireless device;
detecting the passage of a predefined period of time; and
second indicating, via the push-to-talk indicator, that the user of the wireless device may provide audio for transmission.

8. The method of claim 7, wherein the first indicating comprises:
indicating, via a push-to-talk backlit button, that a user of the wireless device may not provide audio for transmission.

9. The method of claim 7, wherein the first indicating comprises:
indicating, via a push-to-talk backlit button that is lit in red color, that a user of the wireless device may not provide audio for transmission.

10. The method of claim 7, wherein the second indicating comprises:
indicating, via a push-to-talk backlit button that is lit in green color, that a user of the wireless device may provide audio for transmission.

11. A push-to-talk wireless device including a push-to-talk indicator, comprising:
a processor for initiating a connection setup procedure with a wireless network;
a receiver for receiving a message from the wireless network indicating establishment of a connection;
a push-to-talk button for pushing when the user desires to provide audio for transmission; and
a push-to-talk indicator for indicating that the user of the wireless device may provide audio for transmission after the connection has been established and the message is received from the wireless network, otherwise for indicating that the user of the wireless device may not provide audio for transmission.

12. The push-to-talk wireless device of claim 11, further comprising:
a transmitter for sending a call request to the wireless network when initiating a connection setup procedure with the wireless network.

13. The push-to-talk wireless device of claim 11, wherein the push-to-talk indicator comprises a backlit button.

14. The push-to-talk wireless device of claim 13, wherein the backlit button emits a red colored light when indicating that the user of the wireless device may not provide audio for transmission.

15. The push-to-talk wireless device of claim 14, wherein the backlit button emits a green colored light when indicating that the user of the wireless device may provide audio for transmission.

16. The push-to-talk wireless device of claim 11, further comprising:
a detector for detecting the user pushing the push-to-talk button; and
a microphone for receiving audio from the user for transmission.

17. The push-to-talk wireless device of claim 11, wherein the push-to-talk indicator comprises any one of:
a graphic;
a text message;
a light emitting device; and
a button.

18. The push-to-talk wireless device of claim 17, wherein the push-to-talk indicator emits a red colored light when indicating that the user of the wireless device may not provide audio for transmission.

19. The push-to-talk wireless device of claim 18, wherein the push-to-talk indicator emits a green colored light when indicating that the user of the wireless device may provide audio for transmission.

20. A computer readable medium on a wireless device including computer instructions for providing a push-to-talk indicator, the computer instructions including instructions for:
indicating, via a push-to-talk indicator, that a user of the wireless device may not provide audio for transmission;
initiating, by the wireless device, a connection setup procedure with a wireless network;
receiving a message from the wireless network indicating establishment of a connection; and
indicating, via the push-to-talk indicator, that the user of the wireless device may provide audio for transmission.

21. The computer readable medium of claim 20, wherein the first instructions for indicating comprise instructions for:
indicating, via a push-to-talk backlit button, that a user of the wireless device may not provide audio for transmission.

22. The computer readable medium of claim 20, wherein the first instructions for indicating comprise instructions for:
indicating, via a push-to-talk backlit button that is lit in red color, that a user of the wireless device may not provide audio for transmission.

23. The computer readable medium of claim 22, wherein the second instructions for indicating comprise instructions for:
indicating, via a push-to-talk backlit button that is lit in green color, that a user of the wireless device may provide audio for transmission.
